(19) United States
(12) Patent Application Publication
(10) Pub. No.: US 2007/0162597 A1
(43) Pub. Date: Jul. 12, 2007

(54) Service notification system

(75) Inventors: Erika Tanaka, Kawasaki (JP); Kenya Nishiki, Chigasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/580,777

(22) Filed: Oct. 13, 2006

(30) Foreign Application Priority Data
Nov. 24, 2005 (JP) 2005-337999

(51) Int. Cl. G06F 15/173

(52) U.S. Cl. 709/224; 340/988; 340/425.5; 340/10.1

(57) ABSTRACT

A service notification system for notifying a service content to a user includes: a location detecting unit for detecting location information of a terminal owned by the user; a service selection unit for selecting a service which is provided to the user based upon attribution information of the user which has been previously registered; a password management unit for creating a password with respect to the selected service; a notifying unit for notifying both the selected service and the produced password to the terminal; and a password identifying unit for identifying a password inputted by the user with respect to the created password.

### INCORPORATION BY REFERENCE

The present application claims priority from Japanese application JP2005-337999 filed on Nov. 24, 2005, the content of which is hereby incorporated by reference into this application.

### BACKGROUND

The present invention is related to a service notification system.

In the Internet world, various sorts of services are present, for instance, services for recommending merchandise related to the users are provided, services for distributing music and images are provided, and so on.

In this connection, one user authentication technique is known (see JP-A-2003-132022, for example) by which user authentication systems for a plurality of different services, existed in the Internet, are unified, whereby a plurality of services are available by a user in such a manner that the user uses one ID and one password by employing common authentication information which is commonly used in the unified authentication systems.

### SUMMARY

In the above-explained user authentication technique described in JP-A-2003-132022, user previous registration is required in order to utilize services in addition to user authentication.

Such services are recently required which are present in the actual world, for instance, shopping malls and town centers.

As these services, the following sorts of services may be conceived. That is, for example, a service is provided which recommends merchandise to be sold with respect to persons who visit in a town center within a predetermined time period, a location information service is provided by which when a user is separated from a friend who has visited together with the user, this user retrieves the present position thereof in real time.

However, these services are provided, depending upon locations. Also, these services themselves are sequentially produced and successively disappear, so that service usable statuses are dynamically changed. As a result, users cannot grasp in advance contents of services which are dynamically changed. On the other hand, in view of security aspects, registration of users with respect to services is necessarily required. However, in such a case that user authentication has been carried out, and thereafter, users try to utilize a dynamically changing service after previous user registration is performed, these users must be previously registered with respect to the respective services. Thus, there is a problem that these users are required to perform cumbersome operations.

As a consequence, an object of the present invention is to provide a service notification system capable of securing security even if pervious registration for utilizing a service is not performed with respect to a dynamically changing service.

To solve the above-explained problems, one of preferred modes of the present invention is given as follows:

That is, a service notification system for notifying a service content to a user is featured by including: a location detecting unit for detecting location of a terminal owned by the user; a service selection unit for selecting a service which is provided to the user based upon attribution information of the user which has been previously registered; a password management unit for creating a password with respect to the selected service; a notifying unit for notifying both the selected service and the produced password to the terminal; and a password identifying unit for identifying a password inputted by the user with respect to the produced password.

Other objects, features and advantages of the invention will become apparent from the following description of the embodiments of the invention taken in conjunction with the accompanying drawings.

### BRIEF DESCRIPTION OF THE DRAWINGS

FIG. 1 is a structural diagram for showing a service notification system according to an embodiment of the present invention.

FIG. 2 is a diagram for schematically indicating a function module and data of the service notification system shown in FIG. 1.

FIG. 3 is a hardware structural diagram of a control system 4 employed in the service notification system.

FIG. 4 is a hardware diagram of a user terminal 12 employed in the service notification system.

FIG. 5 is a flow chart for describing creating/notifying/deleting operations of a password in the service notification system.

FIG. 6 is a flow chart for explaining a detailed process operation of a step 506 of the flow chart shown in FIG. 5.

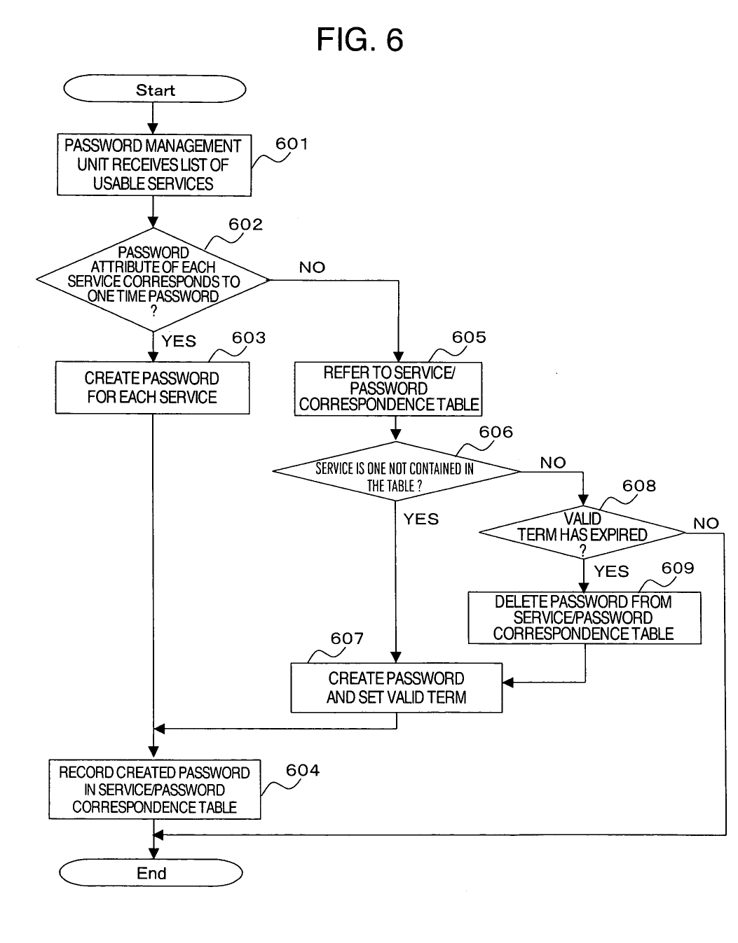

FIG. 7 is a flow chart for explaining a detailed process operation of a step 510 of the flow chart shown in FIG. 5.

FIG. 8 is a flow chart for explaining process operations when a user utilizes a service.

FIG. 9 is a diagram for showing an example as to a user DB (database) 9.

FIG. 10 is a diagram for representing an example as to an area/service correspondence table 26.

FIG. 11 is a diagram for representing an example as to an attribute/service correspondence table 27.

FIG. 12 is a diagram for representing an example as to a service/password correspondence table 28.

### DESCRIPTION OF THE EMBODIMENTS

Referring now to drawings, embodiments of the present invention will be described.

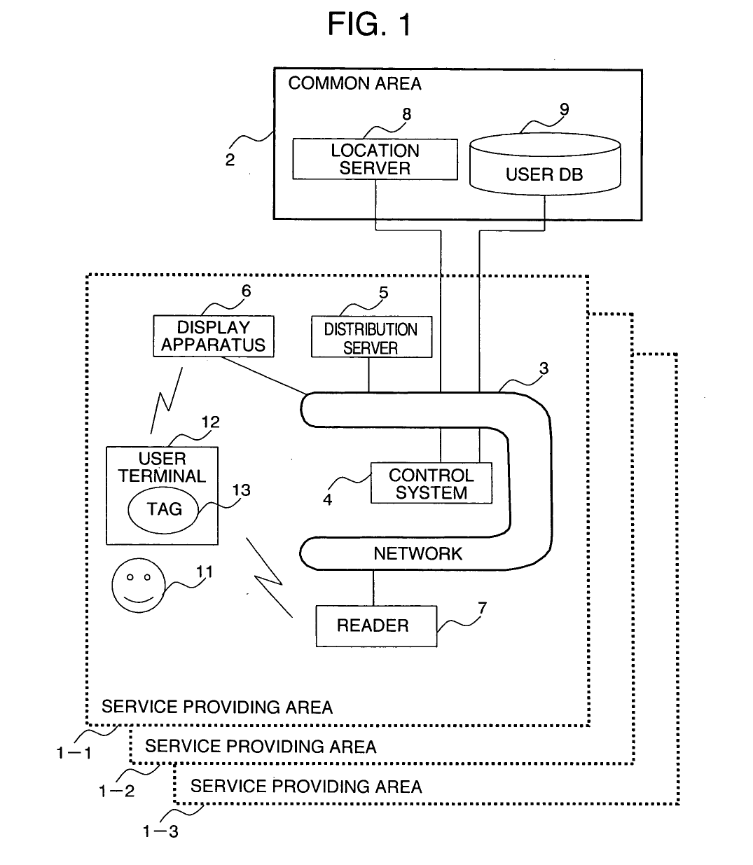

FIG. 1 is a structural diagram of a service notification system according to an embodiment of the present invention.

The service notification system contains service providing area 1 (1-1 to 1-3), and a common area 2.

The service providing area 1 contains a control system 4, a distribution server 5 which provides a contents distributing service, a display apparatus 6, and a reader 7. When the display apparatus 6 receives authentication information from a user terminal 12, the display apparatus 6 provides a service (contents display etc.) with respect to a user 11. The reader 7 transmits information such as an RFID tag to a read control system 4. These structural elements are connected via a network 3 to each other.

The common area 2 contains a location sever 8 which provides a position retrieving service and a user information database (will be abbreviated as “user DB” hereinafter). These structural elements are connected to the network 3.

The user 11 owns a user terminal 12 on which a tag 13 such as an RFID tag is mounted, and which performs a wireless communication. It should be understood that although this embodiment will be explained by employing the RFID tag, the present invention is not limited only thereto. For instance, an IC card for managing entering/leaving actions may be alternatively employed, or such a card into which a passive tag such as a μ-chip has been embedded may be alternatively employed. Also, a GPS apparatus whose location can be detected in a periodic manner may be employed. Furthermore, a terminal which mounts thereof a wireless function may be alternatively employed (wireless function corresponds to RFID tag, wireless access point corresponds to reader, MAC address corresponds to RFID).

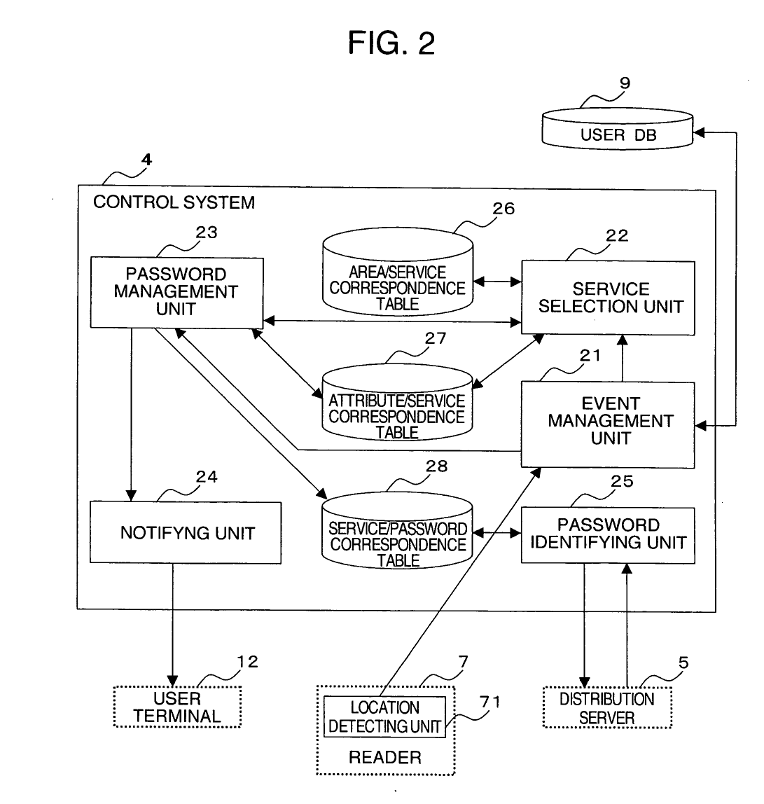

The reader 7 is equipped with a location detecting unit 71 (refer to FIG. 2) which detects positional information of the user terminal 12 when this user terminal 12 is located in a predetermined area. For example, when the user 11 who owns the user terminal 12 enters into the area 1-1 (leaves from area 1-1), the reader 7 detects the RFID tag 13 (cannot detect RFID tag 13).

The apparatus present within the service providing area 1-1 correspond to such apparatus which can be utilized within only the area 1-1, whereas the apparatus present within the common area 2 correspond to such apparatus which can be utilized in any of the service providing areas 1-1 to 1-3. It should be understood that contents which are distributed by the distribution server 5 may be such contents related to services outside an area.

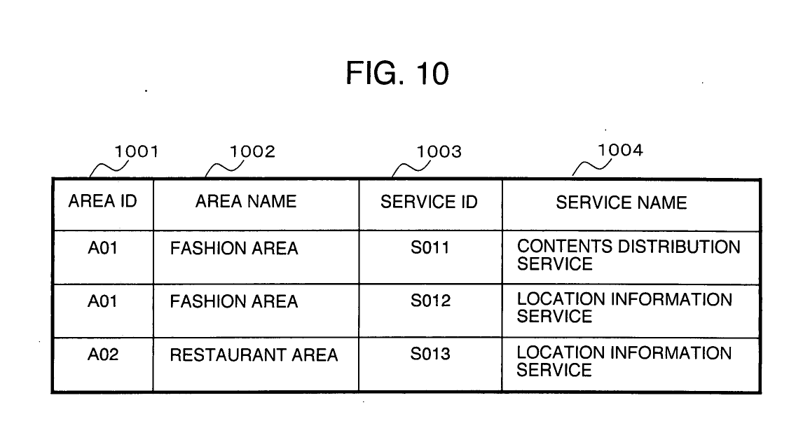

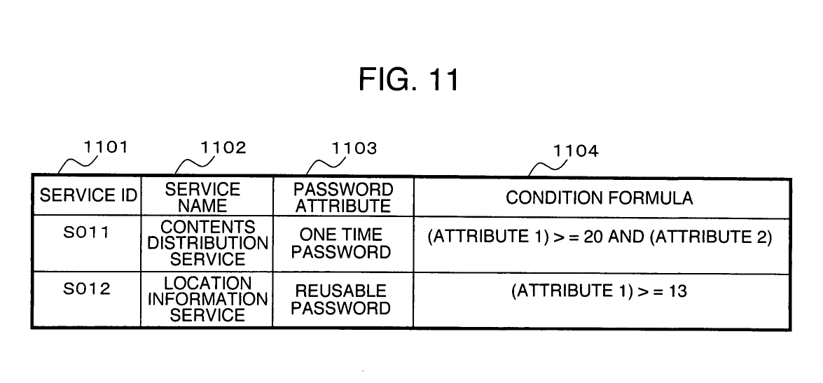

In the present embodiment, services whose usable statuses are dynamically changed are handled. As an operating method, for example, a management system for managing statuses of the services has been provided (alternatively, control system 4 may be provided with this function). Then, services which may be used within areas have been registered in the control system 4. Every time statuses of services are changed (involving such a case that new service is produced), the management system notifies the changed statuses of the services to the control system 4. Then, an event management unit (will be explained later) receives this notification, and then, forms and/or updates both an area/service correspondence table (FIG. 10) and an attribute/service correspondence table (FIG. 11).

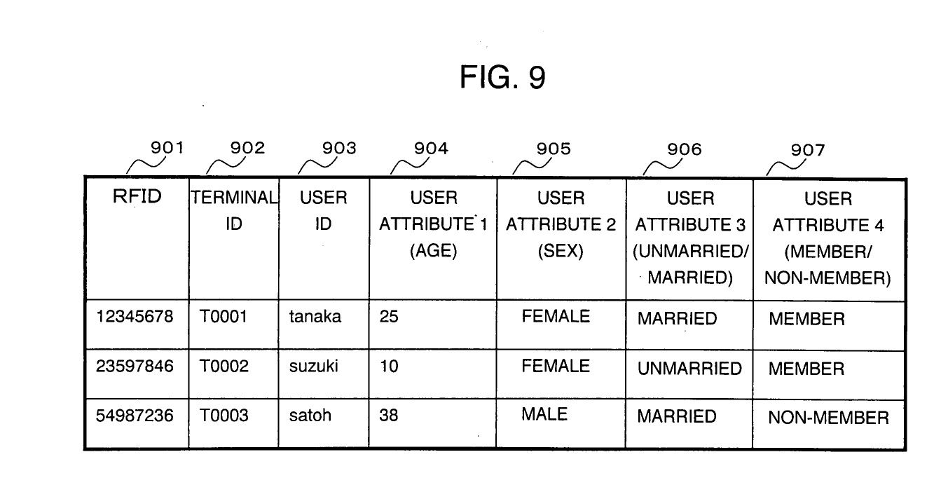

It should also be understood that since not only a content of a service is changed but also an attribute of a user is changed, usable services may be changed. In FIG. 9 which represents a user DB (Database) 9 (will be explained later), information having relatively small changes is exemplified. Alternatively, if such an information (context information) whose contents are changed time to time is added to a service selection condition, then a usable service may be dynamically changed in conjunction with a change in an attribute. As the above-explained context information, which area a user was located before the user is located in this area; which service a user has so far utilized; which person a user joins with, and the like. In the above-explained cases, the management system may notify these status changes to the control system 4 similar to the above-explained case.

FIG. 2 is a diagram for schematically showing a function module and data of the service notification system according to the embodiment. The function module of the control system 4 is arranged by an event management unit 21, a service selection unit 22, a password management unit 23, a notifying unit 24, a password identifying unit 25, an area/service correspondence table 26, an attribute/service correspondence table 27, and a service/password correspondence table 28. The event management unit 21 acquires information (user terminal information) related to a user terminal from the reader 7 so as to manage the acquired user terminal information, retrieves user information from the user DB 9 by employing the acquired user terminal apparatus, and then, notifies the retrieved user information and information (area information) related to an area to the service selection unit 22. The service selection unit 22 selects a service which can be utilized based upon the user information and the area information. The password management unit 23 performs password management (password creation, password deletion, and the like) with respect to the selected service. The notifying unit 24 notifies a set constructed of a usable service and a password of the usable service to the user terminal 12. The password identifying unit 25 receives a password which is transmitted by the user terminal 12 via the distribution server 5, and identifies as to whether or not the received password is identified with the password created by the password management unit 23. The area/service correspondence table 26 has described therein services usable within each of areas for every area. The attribute/service correspondence table 27 has described therein condition formulae related to user attributes in order to use services for every services. The service/password correspondence table 28 manages the passwords which are created with respect to the usable services.

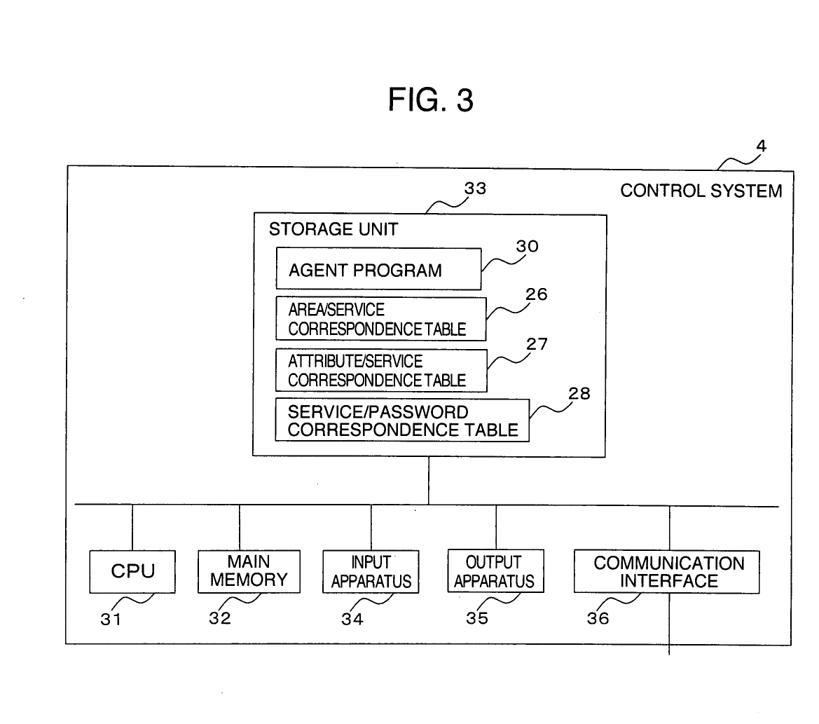

FIG. 3 shows a hardware structural diagram of the control system 4.

The control system 4 is arranged by a CPU 31, a main memory 32, a storage unit 33, an input apparatus 34, an output apparatus 35, and a communication interface 36. These structural elements are connected to each other via a bus, or the like.

The CPU 31 reads out a program stored in the storage unit 33 and reads the program in the main memory 32 so as to execute the read program.

The storage unit 33 has stored thereinto programs and data in order to realize the respective functions shown in FIG. 2. An agent program 30 corresponds to such a program which is provided with various functions as to the event management unit 21, the service selection unit 22, the password management unit 23, the service/password notifying unit 24, the password identifying unit 25, and the like, which are explained with reference to FIG. 2. It should also be noted that since a hardware structural diagram of the reader 7 is similar to the above-explained hardware structure of the storage unit 33 (namely, storage unit of reader 7 has stored program having function of location detecting unit), this hardware structure is not shown. Alternatively, the functions provided in the distribution server 5, the display terminal 6, and the reader 7 may be provided in the control system 4.

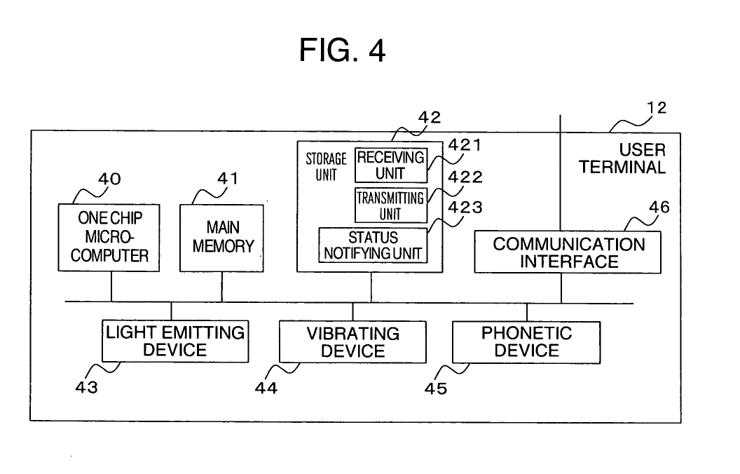

FIG. 4 is a hardware structural diagram of the user terminal 12.

The user terminal 12 is arranged by a one-chip microcomputer 40, a main memory 41, a storage unit 42, a light emitting device 43, a vibrating device 44, a phonetic device 45, and a communication interface 46.

The one-chip microcomputer 40 roads out a program stored in the storage unit 42, and reads the program into the main memory 41 so as to execute the read program.

The above-explained devices 43 to 45 notify existence of a service to a user by way of a light emission, vibrations, and a sound production, respectively. It should be noted that the employment of any one of these devices 43 to 45 may become sufficient, and therefore, all of these devices 43 to 45 are not necessarily required.

The storage unit 42 has stored thereinto programs having functions as to a receiving unit 421, a transmitting unit 422, a status notifying unit 423, and the like. The receiving unit 421 receives notification of a service content and a password corresponding to the service content. When the user enters an input action for utilizing the service content, the transmitting unit 422 transmits a password corresponding to the service content to the service notification system. The status notifying unit 423 notifies a status of the service to the user after the transmitting unit 422 transmits the password. The status notifying unit 423 owns a function capable of notifying a status of a service to the user by employing different methods from each other in the case that the service is available and the service is not available. For instance, in the case that a service is not available, the light emitting device 43 emits light in red, whereas in the case that the service is available, the light emitting device 43 emits light in blue. As a result, the user can grasp a status of the present service. The transmitting unit 422 and the receiving unit 421 instruct the communication interface 46 to transmit data and receive data respectively.

While usable services are displayed on a screen of a user terminal, when a user depresses a portion indicative of a service content which is tried to be used by the user, a password may be transmitted. Alternatively, while a service content is displayed on a display terminal, since the user depresses a portion indicative of the service content displayed thereon, a service ID may be transmitted toward the user terminal; the user terminal may select a password for using a service based upon the transmitted user ID, and may transmit the selected password when the user depresses, for example, an infrared ray emission button.

It should also be understood that the above-explained functions may be alternatively realized by hardware. Further, the program and the data which are employed so as to realize the above-explained functions may be alternatively transferred from a storage medium such as a CD-ROM, or may be alternatively downloaded from other apparatus via a network.

The terminal ID of the user terminal 12 has been previously registered in the user DB 9. There is such an initial condition that the above-explained user terminal 12 has been authenticated (user authentication) as a normally registered apparatus by employing a PKI (public key identification), and the like. It should also be noted that although user information necessary for the user authentication may be previously registered with respect to the control system 4, another such previous registration may be carried out. That is, for example, while a management system is provided in the common area 2, the user information necessary for the user authentication may be alternatively registered in this management system. As a consequence, if the user information necessary for the user authentication is once registered in the management system, then the user may be communicated with the control system 4 of any one of these areas even when the user is moved to any area.

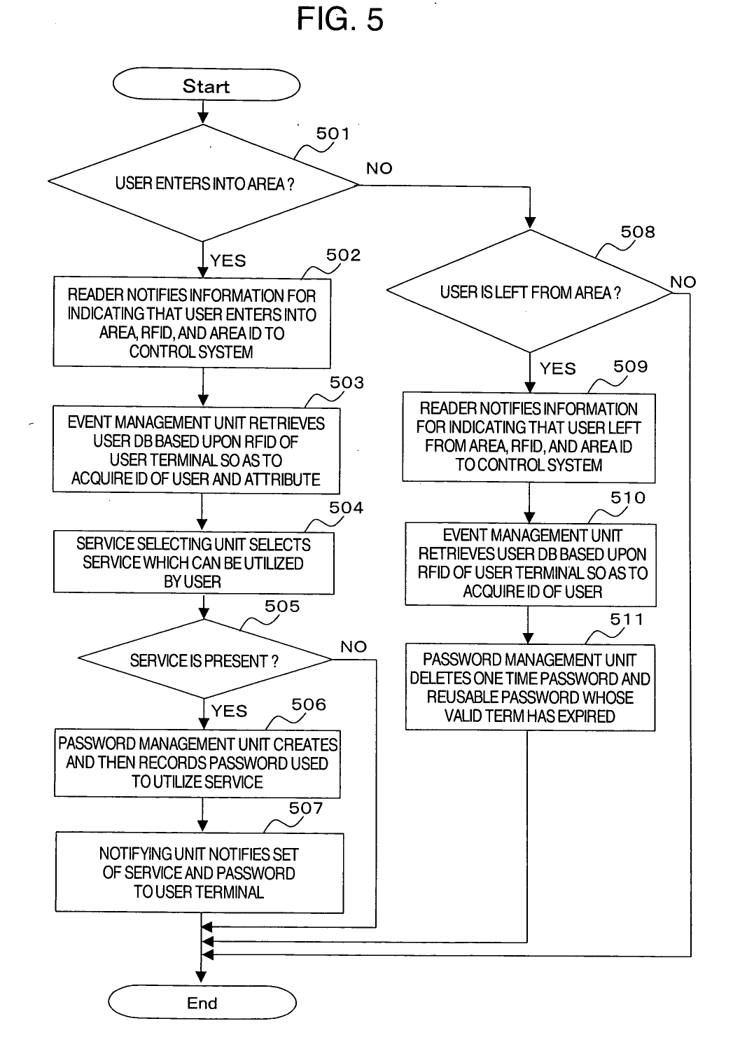

FIG. 5 is a flow chart for explaining process operations in the case that a password is created, notified, and deleted. The below-mentioned explanation is made that the function module shown in FIG. 2 is, as it were, hardware (function module is processing major subject). Apparently, a major subject in such a case that the function module is realized by software is the CPU 31 which executes the program.

In this flow chart, first of all, the reader 7 judges as to whether or not the user 11 enters into an area (step 501). For example, in such a case that a new RFID tag can be detected, the reader 7 judges that the user 11 enters into the area. When the user 11 enters into the area, the reader 7 notifies information for indicating that the user 11 enters into the area, an RFID, and an area ID (information for identifying area) to the control system 4 (step 502). The event management unit 21 retrieves the user DB 9 based upon the received RFID so as to acquire both a user ID and a user attribute (step 503). Then, the event management unit 21 transfers the acquired ID and attribute to the service selection unit 22.

FIG. 9 is a diagram for representing an example of the above-explained user DB 9. The user DB 9 is constituted by an RFID 901, a terminal ID 902 of a user terminal 12, a user ID 903 of a user who owns the user terminal 12, a user attribute 1 (age) 904, a user attribute 2 (sex) 905, a user attribute 3 (unmarried/married) 906, and a user attribute 4 (member/non-member) 907.

Next, the service selection unit 22 selects such a service which can be utilized by this user within the relevant area (step 504).

FIG. 10 is a diagram for showing an example of the area/service correspondence table 26. The area/service correspondence table 26 is arranged by an area ID 1001, an area name 1002, a service ID 1003 of a service which can be utilized within the relevant area, and a service name 1004.

FIG. 11 is a diagram for representing an example of the attribute/service correspondence table 27. The attribute/service correspondence table 27 is constituted by a service ID 1101, a service name 1102, a password attribute 1103 of a password which is produced by utilizing the relevant service, and a condition formula 1104 of the user attribute.

A concrete explanation is made of the above-described step 504. That is, in this step 504, the service selection unit 22 extracts a service corresponding to the area where the user is present from the services contained in the area/service correspondence table 26. Next, the service selection unit 22 inputs the user attribute acquired in the step 503 into the condition formula 1104 which corresponds to each of the extracted services in the attribute/service correspondence table 27, and then, defines such a service outputted as this result as a service which can be utilized by the user. Next, the service selection unit 22 judges as to whether or not such a service available by the user is present (step 505). When the services are present, the password management unit 23 creates passwords which are used so as to utilize these services respectively, and then, records the resultant passwords in the service/password correspondence table 28 (step 506).

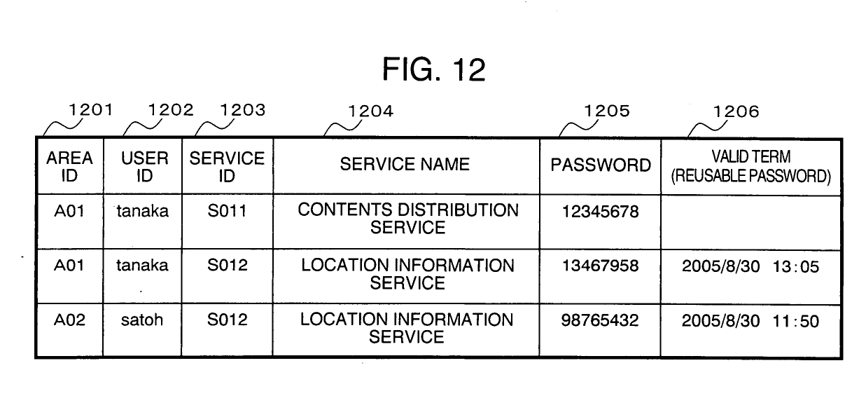

FIG. 12 is a diagram for showing an example of the service/password correspondence table 28. The service/password correspondence table 28 is arranged by an area ID 1201, a user ID 1202, a service ID 1203 of a service which can be utilized by the user within the relevant area, a service name 1204 of the service, a password 1205 used so as to utilize the relevant service, and a validate term 1026 in the case that a service attribute is “reusable.” The notifying unit 24 notifies the created password to the user terminal 12 in combination with the service ID (step 507).

In the step 505, when the usable service is not present, the process operation is accomplished.

Now, a detailed explanation is made of the process operation in the step 506. When the password management unit 23 receives a list of services which can be utilized by the user from the service selection unit 22 (step 601), the password management unit 23 refers to the attribute/service correspondence table 27 so as to confirm the password attributes 1103 of the respective services (step 602). In the case that this password attribute 1103 is “one time”, password the password management unit 23 creates a password which becomes valid only within the relevant area for every service (step 603). In the case that the password attribute 1103 is “reusable”, the password management unit 23 refers to the service/password correspondence table 28 (step 605), and confirms as to whether or not the relevant service corresponds to a service which is not contained in this service/password correspondence table 28 (step 606). When the service is one which is not contained in the service/password correspondence table 28, the password management unit 23 creates a password, and sets a valid term with respect to the created password (step 607). When the service is not the one which is not contained in this service/password correspondence table 28, the password management unit 23 confirms a valid term of this password (step 608). If the confirmed valid term has expired, then the password management unit 23 deletes both the password and the service information corresponding thereto from the service/password correspondence table 28 (step 609), and newly creates a password, and then, sets a valid term with respect to this newly created password (step 607). The password management unit 23 records the created password in the service/password correspondence table 28 (step 604).

It should also be understood that “one-time password” normally implies such a password which may become valid only one time. However, in this embodiment, such a password is also involved in the above-explained one-time password, namely, this password may be used many times while the user is located within the relevant area, but if the user once leaves from this area, then the password disappears.

Returning back to FIG. 5, in the case where a phenomenon other than that the user 11 enters into the area 1-1 is detected in the step 501 (for example, when the RFID tag 13 having been detected heretofore cannot be detected), the reader 7 judges as to whether or not the user 11 left from the area 1-1 (step 508). When the user 11 left from the area 1-1, the reader 7 notifies information for indicating that the user 11 left from the area 1-1, an RFID, and an area ID to the control system 4 (step 509). The event management unit 21 retrieves the user DB 9 based upon the received RFID so as to acquire a user ID (step 510). Then, the event management unit 21 transfers the acquired ID and an attribute to the service selection unit 22. The password management unit 23 refers to the password of this user from the service/password correspondence table 28, and deletes a one-time password to which this password attribute belongs, and such a password that the relevant password attribute is reusable and the valid term has expired (step 511), and then, the process operation is accomplished.

In the step 508, if the user 11 does not leave from the area 1-1, then the reader 7 directly accomplishes the process operation.

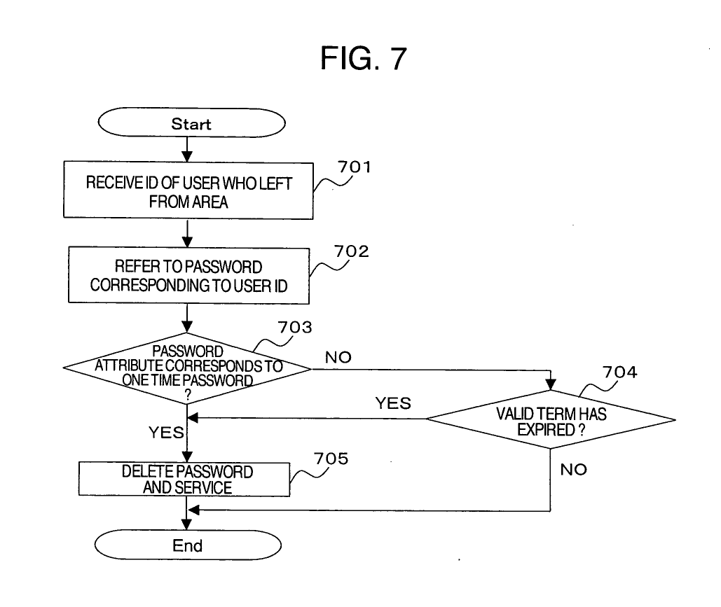

A detailed explanation as to the step 510 will now be explained with reference to FIG. 7. When the password management unit 23 receives a user ID of a user who left from an area from the event management unit 21 (step 701), the password management unit 23 confirms a service related to the user from the service/password correspondence table 28. The password management unit 23 refers to the attribute/service correspondence table 27 (step 702) so as to confirm a password attribute 1103 of each of the services (step 703). In the case that the confirmed password attribute 1103 corresponds to the “one-time password”, the password management unit 23 deletes the “one-time password” and the service information corresponding to this “one-time password” from the attribute/service correspondence table 27 (step 705). In the case that the confirmed password attribute 1103 corresponds to the “reusable password”, the password management unit 23 confirms a valid term of this “reusable password” (step 704). If the valid term has expired, then the password management unit 23 deletes the “reusable password” and the service information corresponding to this “reusable password” from the attribute/service correspondence table 27 (step 705). If the valid term has not expired, then the process operation is ended.

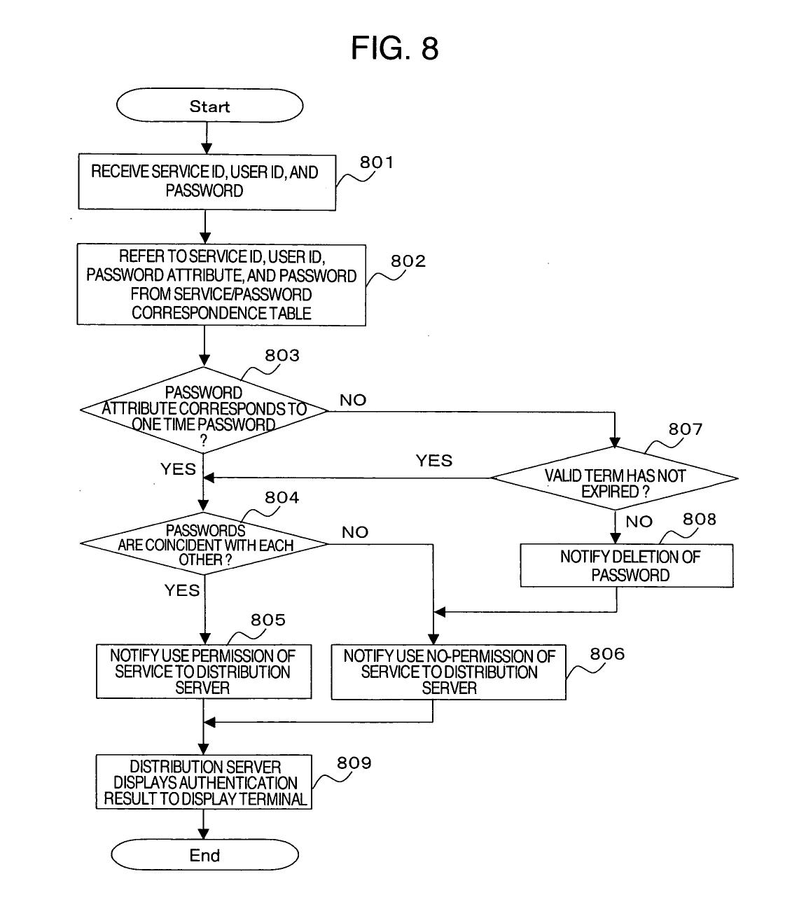

Next, a description is made of process operations executed when the user 11 utilizes a service with reference to FIG. 8.

When the user 11 transmits both a user ID and a password from the user terminal 12 with respect to the display apparatus 6, the password identifying unit 25 receives a service ID, the user ID, and the password via the distribution server 5 (step 801), and refers to the service ID, a password attribute, and the password based upon the user ID from the service password correspondence table 28 (step 802), and then, judges as to whether or not the password attribute corresponds to a “one time” attribute (step 803).

Next, in the case that the password attribute corresponds to “one time” password, the password identifying unit 25 judges as to whether or not the passwords are coincident with each other (step 804). When the passwords are coincident with each other, the password identifying unit 25 notifies a use permission with respect to the distribution server 5 (step 805). To the contrary, when the passwords are not coincident with each other, the password identifying unit 25 notifies a use non-permission with respect to the distribution server 5 (step 806). When the password attribute corresponds to the “reusable password”, the password identifying unit 25 confirms a valid term of this “reusable” password (step 807). If the confirmed term is within the valid term, then the password identifying unit 25 judges as to whether or not the passwords are coincident with each other (step 804), and when the passwords are coincident with each other, the password identifying unit 25 notifies a use permission (step 805). When the passwords are not coincident with each other, the password identifying unit 25 notifies a use non-permission (step 806). In the case that this password valid term has expired, the password identifying unit 25 issues a password deletion notification with respect to the password management unit 23 (step 808), and notifies a use non-permission with respect to the distribution server 5 (step 806). Upon receipt of the notification, the distribution service 5 displays an authentication result on the display apparatus 6 (step 809).

In accordance with the present embodiment, even if the user is not previously registered with respect to the respective services, the authentication information which is employed so as to utilize the service can be produced and the produced authentication information can be notified.

In accordance with the present invention, such a service notification system can be provided which are capable of securing the security even if the previous registration for utilizing the services is not previously registered with respect to the service which is dynamically changed.

It should be further understood by those skilled in the art that although the foregoing description has been made on embodiments of the invention, the invention is not limited thereto and various changes and modifications may be made without departing from the spirit of the invention and the scope of the appended claims.

1. A service notification system for notifying a service content to a user, comprising:
a location detecting unit for detecting location information of a terminal owned by the user;
a service selection unit for selecting a service which is provided to said user based upon attribution information of said user which has been previously registered;
a password management unit for creating a password with respect to said selected service;
a notifying unit for notifying both said selected service and said created password to said terminal; and
a password identifying unit for identifying a password inputted by said user with respect to said created password.

2. A service notification system according to claim 1, wherein:
said location detecting unit detects said location information when said terminal is located within a predetermined range.

3. A service notification system according to claim 2, wherein:
said location detecting unit detects that said terminal is left from said predetermined range; and
said password detecting unit deletes a password related to the terminal which is left from said predetermined range.

4. A service notification system according to claim 1, further comprising:
first information in which information indicative of said predetermined range is defined in correspondence with a service which can be provided within said predetermined range; wherein:
said service selection unit selects said service based upon said first information.

5. A service notification system according to claim 4, further comprising:
second information in which information indicative of said service is defined in correspondence with a condition formula related to the attribute information of said user; wherein:
said service selection unit selects said service based upon said second information.

6. A service notification system according to claim 5, wherein:
said second information includes information indicative of a password attribute; and
said password management unit creates said password based upon said password attribute.

7. A service notification system according to claim 6, wherein:
in the case that the attribute of said password corresponds to a so-called “one-time password”, said password management unit creates such a password which is valid only within said predetermined range.

8. A service notification system according to claim 7, wherein:
in the case that the attribute of said password corresponds to a reusable password, said password management unit judges as to whether or not a valid term is applied to said password.

9. A service notification system according to claim 8, wherein:
in the case that said service is not recorded in said first information and the attribute of said password is the reusable password, said password management unit applies the valid term to said password.

10. A service notification system according to claim 9, wherein:
said location detecting unit detects that said terminal is left from said predetermined range; and
said password management unit deletes said produced password in response to said detection result.

11. A service notification system according to claim 1, wherein:
said terminal is comprised of at least one device selected from a light emitting device, a vibrating device, and a phonetic device; and
upon receipt of the notification of said notifying unit, said terminal issues notification to said user by activating at least one device selected from the light emission by said light emitting device, the vibration by said vibrating device, and the sound produced by said phonetic device.

12. A terminal owned by a user who utilizes the service notification system recited in claim 1, comprising;
a receiving unit for receiving both notification of a service content and a password corresponding to said service content from said service notification system;
a transmitting unit for transmitting said password corresponding to said service content to said service notification system when said user performs an input operation so as to utilize said service content; and
a status notifying unit for notifying a status of said service to said user after said transmitting unit transmits said password; wherein:
said status notifying unit notifies the status of the service to the user in the case that said service is available and is not available by employing the different means from each other.
